(19) United States
(12) Patent Application Publication
(10) Pub. No.: US 2026/0361929 A1
(43) Pub. Date: Nov. 12, 2026

(54) LIVE BROADCAST DATA PROCESSING METHOD AND SYSTEM

(71) Applicant: SHANGHAI BILIBILI TECHNOLOGY CO., LTD., Shanghai (CN)

(72) Inventors: Ran Tang, Shanghai (CN); Jun Jiang, Shanghai (CN); Long Zheng, Shanghai (CN); Yongming Liu, Shanghai (CN)

(21) Appl. No.: 19/123,914

(22) PCT Filed: Jul. 6, 2023
(86) PCT No.: PCT/CN2023/106150

§ 371 Date: Apr. 24, 2025

(30) Foreign Application Priority Data
Oct. 25, 2022 (CN) 202211311544.0

(51) Int. Cl. H04N 21/2187; G10L 15/26; H04N 21/488

(52) U.S. Cl. CPC H04N 21/2187; G10L 15/26; H04N 21/4884

(57) ABSTRACT

Embodiments of the application provide a livestreaming data processing method and system. The livestreaming data processing method includes: decoding a received initial live stream to generate an audio stream and a first video stream; performing speech recognition on the audio stream to generate a corresponding recognition text, and determining time interval information between a generation time of the recognition text and a reception time of the audio stream; using the recognition text as subtitle information, and adding the subtitle information and the time interval information to the first video stream to generate a second video stream; and encoding the second video stream and the audio stream to generate a to-be-pushed live stream, and returning the to-be-pushed live stream to a client.

The application claims priority to Chinese Patent Application No. 202211311544.0, filed on Oct. 25, 2022 and entitled “LIVESTREAMING DATA PROCESSING METHOD AND SYSTEM”, which is incorporated herein by reference in its entirety.

### TECHNICAL FIELD

Embodiments of the application relate to the field of computer technologies, and in particular, to a livestreaming data processing method. One or more embodiments of the application also relate to a livestreaming data processing system, a computing device, and a computer-readable storage medium.

### BACKGROUND

With rapid development of the live audio/video industry, requirements on high definition picture quality, low delay, sound picture synchronization, and the like are optimized to the extreme by using a data stream transmission technology. However, this still does not meet needs of users.

In some special scenarios, for example, a large-scale sports event, a large-scale conference report, and online education and training, it is necessary to translate livestreaming in real time and add language subtitles. For the subtitles, a live stream needs to be recorded first, then an audio stream is extracted, and burned into a video after manual or machine translation, so that the subtitles can be displayed during playback. However, this processing manner cannot bring a livestreaming effect to audiences having a language barrier or a hearing impairment. The inventor is aware that although a livestreaming real-time subtitle generation technology, for example, a livestreaming bullet-screen comment, has been developed, there are some disadvantages in the technology, for example, a subtitle is not synchronized with a sound, sometimes ahead and sometimes behind, which results in extremely poor user experience for audiences and fails to meet needs of the audiences. Therefore, an effective method is urgently needed to resolve this kind of problem.

### SUMMARY

In view of this, an embodiment of the application provides a livestreaming data processing method. One or more embodiments of the application also relate to a livestreaming data processing apparatus, a livestreaming data processing system, a computing device, and a computer-readable storage medium, to resolve technical disadvantages of high costs, low efficiency, and a delay in generating a live subtitle in a related technology.

According to a first aspect of the embodiments of the application, a livestreaming data processing method is provided and includes:
decoding a received initial live stream to generate an audio stream and a first video stream;
performing speech recognition on the audio stream to generate a corresponding recognition text, and determining time interval information between a generation time of the recognition text and a reception time of the audio stream;
using the recognition text as subtitle information, and adding the subtitle information and the time interval information to the first video stream to generate a second video stream; and
encoding the second video stream and the audio stream to generate a to-be-pushed live stream, and returning the to-be-pushed live stream to a client.

According to a second aspect of the embodiments of the application, a livestreaming data processing apparatus is provided and includes:
a decoding module, configured to decode a received initial live stream to generate an audio stream and a first video stream;
a recognition module, configured to perform speech recognition on the audio stream to generate a corresponding recognition text, and determine time interval information between a generation time of the recognition text and a reception time of the audio stream;
an addition module, configured to use the recognition text as subtitle information, and add the subtitle information and the time interval information to the first video stream to generate a second video stream; and
an encoding module, configured to encode the second video stream and the audio stream to generate a to-be-pushed live stream, and return the to-be-pushed live stream to a client.

According to a third aspect of the embodiments of the application, another livestreaming data processing method is provided and includes:
receiving and buffering a to-be-pushed live stream returned by a livestreaming server;
decoding the to-be-pushed live stream to generate a corresponding audio stream, video stream, and subtitle information, and time interval information corresponding to the subtitle information, wherein the time interval information is determined by the livestreaming server according to a generation time of the subtitle information and a reception time of the audio stream;
determining a display time of the subtitle information according to the time interval information; and
when determining a play back condition of the to-be-pushed live stream is met, synchronously playing the video stream and the audio stream, and displaying the subtitle information based on the display time.

According to a fourth aspect of the embodiments of the application, another livestreaming data processing apparatus is provided and includes:
a receiving module, configured to receive and buffer a to-be-pushed live stream returned by a livestreaming server;
a decoding module, configured to decode the to-be-pushed live stream to generate a corresponding audio stream, video stream, and subtitle information, and time interval information corresponding to the subtitle information, where the time interval information is determined by the livestreaming server according to a generation time of the subtitle information and a reception time of the audio stream;
a determining module, configured to determine a display time of the subtitle information according to the time interval information; and
a display module, configured to: when determining a playback condition of the to-be-pushed live stream is met, synchronously play the video stream and the audio stream, and display the subtitle information based on the display time.

According to a fifth aspect of the embodiments of the application, a livestreaming data processing system is provided and includes:
a livestreaming server and a client.

The livestreaming server is configured to: decode a received initial live stream to generate an audio stream and a first video stream; perform speech recognition on the audio stream to generate a corresponding recognition text, and determine time interval information between a generation time of the recognition text and a reception time of the audio stream; use the recognition text as subtitle information, and add the subtitle information and the time interval information to the first video stream to generate a second video stream; and encode the second video stream and the audio stream to generate a to-be-pushed live stream, and return the to-be-pushed live stream to the client.

The client is configured to: receive and buffer the to-be-pushed live stream, decode the to-be-pushed live stream to obtain the audio stream, the second video stream, the subtitle information, and the time interval information, determine a display time of the subtitle information according to the time interval information, and when determining a playback condition of the to-be-pushed live stream is met, synchronously play the second video stream and the audio stream, and display the subtitle information based on the display time.

According to a sixth aspect of the embodiments of the application, a computing device is provided and includes:
a memory and a processor.

The memory is configured to store computer-executable instructions, the processor is configured to execute the computer-executable instructions, and when the processor executes the computer-executable instructions, the steps of the livestreaming data processing method are implemented.

According to a seventh aspect of the embodiments of the application, a computer-readable storage medium is provided and stores computer-executable instructions. When the instructions are executed by a processor, the steps of the livestreaming data processing method are implemented.

The embodiments of the application implement the livestreaming data processing method and system. The livestreaming data processing method includes: decoding a received initial live stream to generate an audio stream and a first video stream; performing speech recognition on the audio stream to generate a corresponding recognition text, and determining time interval information between a generation time of the recognition text and a reception time of the audio stream; using the recognition text as subtitle information, and adding the subtitle information and the time interval information to the first video stream to generate a second video stream; and encoding the second video stream and the audio stream to generate a to-be-pushed live stream, and returning the to-be-pushed live stream to a client.

In the embodiments of the application, the livestreaming server performs speech recognition on the audio stream to generate the corresponding recognition text, and records a time interval between the generation time of the recognition text and the time of receiving the audio stream. The time interval may be used to represent duration consumed by the livestreaming server to perform speech recognition on the audio stream in the initial live stream after receiving the initial live stream. Therefore, after the recognition text and the time interval information are added to the video stream and returned to the client, the client can obtain, through pre-parsing, the subtitle information carried in the to-be-pushed live stream, and determine the display time of the subtitle information according to the time interval information between the generation time of the subtitle information and the time of receiving the audio stream by the livestreaming server, that is, determine a display time of a complete subtitle corresponding to the to-be-pushed live stream, to display the complete subtitle in advance based on the display time. This helps reduce costs of generating the subtitle, improve efficiency of generating the subtitle, and further avoid out-of-synchronization between the subtitle and a video picture or an audio, thereby helping meet a need of a user for watching the live subtitle in a process of watching livestreaming, and helping improve experience of the user in watching the livestreaming.

### BRIEF DESCRIPTION OF DRAWINGS

FIG. 1 is a diagram of an architecture of a livestreaming data processing system according to an embodiment of the application;

FIG. 2 is a flowchart of a livestreaming data processing method according to an embodiment of the application;

FIG. 3 is a flowchart of an another livestreaming data processing method according to an embodiment of the application;

FIG. 4 is a schematic diagram of interaction in which a livestreaming data processing method according to an embodiment of the application is applied to the livestreaming field;

FIG. 5 is a schematic diagram of a structure of a livestreaming data processing apparatus according to an embodiment of the application;

FIG. 6 is a schematic diagram of a structure of an another livestreaming data processing apparatus according to an embodiment of the application; and

FIG. 7 is a block diagram of a structure of a computing device according to an embodiment of the application.

### DESCRIPTION OF EMBODIMENTS

Many specific details are described in the following descriptions to facilitate full understanding of the application. However, the application can be implemented in many other manners different from those described herein. A person skilled in the art can make similar promotion without departing from the connotation of the application. Therefore, the application is not limited to specific implementations disclosed below.

Terms used in one or more embodiments of the application are merely used to describe specific embodiments, and are not intended to limit the one or more embodiments of the application. The terms “a” and “the” that are in singular forms and that are used in one or more embodiments and the appended claims of the application are also intended to include plural forms, unless otherwise specified in the context clearly. It should be further understood that the term “and/or” used in one or more embodiments of the application indicates and includes any or all possible combinations of one or more associated listed items.

It should be understood that although the terms such as “first” and “second” may be used in one or more embodiments of the application to describe various types of information, the information should not be limited to these terms. These terms are merely used to distinguish between information of a same type. For example, without departing from the scope of the one or more embodiments of the application, “first” may also be referred to as “second”, and similarly, “second” may also be referred to as “first”. Depending on the context, for example, the word “if” used herein can be interpreted as “while”, “when”, or “in response to determining”.

Terms used in one or more embodiments of the application are explained first.

Live broadcast: In a broad sense, live broadcast includes live broadcast of a television station. Herein, live broadcast refers to live streaming of a network video. A live audio/video is pushed to a server in a form of a media stream (push stream). If there is an audience watching the livestreaming, after receiving a request from a user, the server transmits a video to a player of a website, an APP, and a client, and plays the video in real time.

H264 encoding: H264 usually refers to H.264. H.264 is a highly compressed digital video codec standard proposed by the Joint Video Team (JVT), which is jointly composed of the ITU-T Video Coding Experts Group (VCEG) and the ISO/IEC Moving Picture Experts Group (MPEG). H265 encoding: H.265 is a new video coding standard developed by the ITU-T VCEG after H.264. The H.265 standard is centered around the video coding standard H.264, retaining some original technologies while improving some related technologies.

Supplemental Enhancement Information (SEI): belongs to a code stream category. The SEI provides a method for adding additional information to a video code stream, and is one of features of these video compression standards H.264/H.265.

Speech recognition technology: is a technology in which a machine converts a voice signal into a corresponding text or command in recognition and understanding processes.

GRPC: is a type of a Remote Procedure Call (RPC) framework, is a high-performance, open-source and universal RPC framework developed based on a Protocol Buffers (ProtoBuf) serialization protocol, and supports many development languages.

Transcoding: A video transcoding technology converts a video signal from one format to another format.

In the application, a livestreaming data processing method is provided. One or more embodiments of the application also relate to a livestreaming data processing apparatus, a livestreaming data processing system, a computing device, and a computer-readable storage medium, which are described in detail in the following embodiments.

In a specific implementation, subtitle information in the embodiment of the application may be presented in a client, for example, a large video playback device, a game machine, a desk computer, a smartphone, a pad, a Moving Picture Experts Group Audio Layer III (MP3) player, a Moving Picture Experts Group Audio Layer IV (MP4) player, a portable laptop computer, an ebook reader, or another display terminal.

In addition, the subtitle information in the embodiment of the application may be applied to any video or audio that can present a subtitle, for example, a subtitle may be presented in a live video or a recorded video, and a subtitle may be presented in an audio of online or offline song listening or book listening.

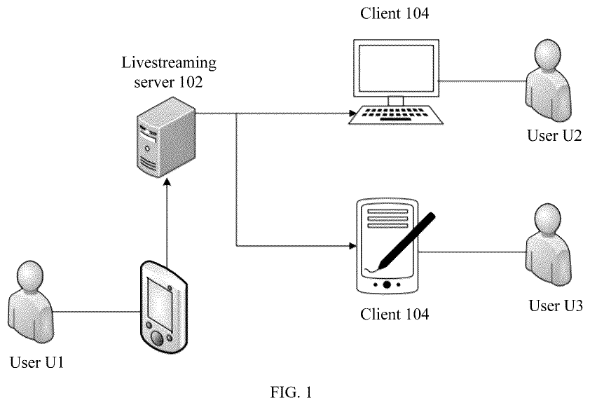

FIG. 1 is a diagram of an architecture of a livestreaming data processing system according to an embodiment of the application. The livestreaming data processing system includes:
a livestreaming server 102 and a client 104.

The livestreaming server 102 is configured to: decode a received initial live stream to generate an audio stream and a first video stream; perform speech recognition on the audio stream to generate a corresponding recognition text, and determine time interval information between a generation time of the recognition text and a reception time of the audio stream; use the recognition text as subtitle information, and add the subtitle information and the time interval information to the first video stream to generate a second video stream; and encode the second video stream and the audio stream to generate a to-be-pushed live stream, and return the to-be-pushed live stream to the client 104.

The client 104 is configured to: receive and buffer the to-be-pushed live stream, decode the to-be-pushed live stream to obtain the audio stream, the second video stream, the subtitle information, and the time interval information, determine a display time of the subtitle information according to the time interval information, and when it is determined that a playback condition of the to-be-pushed live stream is met, synchronously play the second video stream and the audio stream, and display the subtitle information based on the display time.

Specifically, in FIG. 1, a user U1 performs livestreaming by using an intelligent terminal, and pushes a generated initial live stream to the livestreaming server 102. The livestreaming server 102 decodes the received initial live stream to generate an audio stream and a first video stream; then performs speech recognition on the audio stream to generate a corresponding recognition text, and determines time interval information between a generation time of the recognition text and a reception time of the audio stream; afterward uses the recognition text as subtitle information, and adds the subtitle information and the time interval information to the first video stream to generate a second video stream; and furthermore encodes the second video stream and the audio stream to generate a to-be-pushed live stream. When a user U2 and a user U3 watch the livestreaming of the user U1, the livestreaming server may push the to-be-pushed live stream to the client 104 of the user U2 and the user U3.

In a process of playing the live stream for the user by the client 104, the client 104 may pre-pull a to-be-pushed live stream of specific duration from the livestreaming server and buffer the to-be-pushed live stream. In this case, the client 104 may decode the buffered to-be-pushed live stream in advance, to obtain subtitle information included in the to-be-pushed live stream; then may determine a display time of the subtitle information according to time interval information between a generation time of the subtitle information carried in the to-be-pushed live stream and the reception time of the audio stream by the livestreaming server 102; and when it is determined that a playback condition of the to-be-pushed live stream is met, synchronously plays a video stream and the audio stream obtained through decoding, and displays the subtitle information based on the display time.

In the embodiment of the application, in the foregoing processing manner, the client can obtain, through pre-parsing, the subtitle information carried in the to-be-pushed live stream, and determine the display time of the subtitle information according to the time interval information between the generation time of the subtitle information and the time of receiving the audio stream by the livestreaming server, that is, determine a display time of a complete subtitle corresponding to the to-be-pushed live stream, to display the complete subtitle in advance based on the display time. This helps reduce costs of generating the subtitle, improve efficiency of generating the subtitle, and further avoid out-of-synchronization between the subtitle and a video picture or an audio, thereby helping meet a need of the user for watching the live subtitle in a process of watching the livestreaming, and helping improve experience of the user in watching the livestreaming.

The foregoing describes a schematic solution of the livestreaming data processing system in the embodiment. It should be noted that the technical solution of the livestreaming data processing system and a technical solution of the following livestreaming data processing method belong to a same concept. For details not described in detail in the technical solution of the livestreaming data processing system, refer to the descriptions of the technical solution of the following livestreaming data processing method.

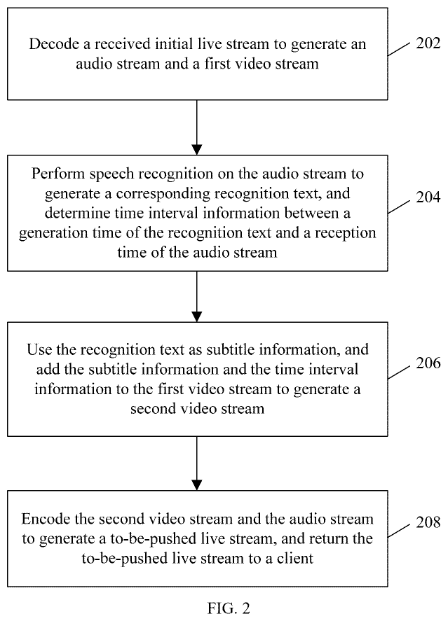

FIG. 2 is a flowchart of a livestreaming data processing method according to an embodiment of the application. The livestreaming data processing method includes the following steps:
Step 202: Decode a received initial live stream to generate an audio stream and a first video stream.

Specifically, the livestreaming data processing method provided in the embodiment of the application is applied to a livestreaming server. The initial live stream is a live stream pushed by an online streamer to a livestreaming server in a livestreaming process.

In a process of performing livestreaming by using an intelligent terminal of the online streamer, the online streamer may push, by using the intelligent terminal, a live stream generated in the livestreaming process to the livestreaming server, so that when another user needs to watch the livestreaming of the online streamer, the livestreaming server can push the live stream pushed by the online streamer to a user terminal (client) of the another user.

Currently, most livestreaming is livestreaming without subtitles. However, in some special scenarios, for example, a large-scale sports event, a large-scale conference report, and online education and training, it is necessary to translate the livestreaming in real time and add language subtitles. For the subtitles, a live stream needs to be recorded first, then an audio stream is extracted, and burned into a video after manual or machine translation, so that the subtitles can be displayed during playback. However, this processing manner cannot bring a livestreaming effect to audiences having a language barrier or a hearing impairment.

In addition, even if a livestreaming real-time subtitle generation technology, for example, a livestreaming bullet-screen comment, has been developed currently, this technology often has a problem of a subtitle being out of synchronous with a video picture or a sound, which results in extremely poor user experience in watching the livestreaming and fails to meet needs of the users. Based on this, in the embodiment of the application, after receiving the initial live stream pushed by the online streamer, the livestreaming server may decode the initial live stream to obtain the audio stream and the first video stream, may perform speech recognition on the audio stream to obtain a corresponding recognition text, and then uses the recognition text as subtitle information to generate a second video stream for adding to the first video stream. Therefore, after a result of encoding the audio stream and the second video stream is pushed to the client of the user, the client can obtain the subtitle information through decoding, and display the subtitle information while synchronously playing the audio stream and the second video stream for the user, thereby avoiding a problem of a live subtitle being out of synchronous with a live video picture or an audio in a process in which the user watches the livestreaming in real time, to meet a need of the user for watching the live subtitle in a process of watching the livestreaming, and improve experience of the user in watching the livestreaming.

In a specific implementation, decoding the received initial live stream may be specifically implemented in the following manner:
determining a to-be-played live stream buffered by the client, and determining a generation time corresponding to the to-be-played live stream; and
obtaining, according to a live stream identifier corresponding to the to-be-played live stream and the generation time corresponding to the to-be-played live stream, an initial live stream corresponding to the live stream identifier in a preset time interval, and decoding the initial live stream, where the preset time interval is later than the generation time.

In addition, the client decodes the to-be-played live stream to correspondingly generate a corresponding to-be-played audio stream, a to-be-played video stream, a to-be-displayed subtitle, and a display time corresponding to the to-be-displayed subtitle; and
when it is determined that a playback condition of the to-be-played live stream is met, synchronously plays the to-be-played video stream and the to-be-played audio stream, and displays the to-be-displayed subtitle based on the display time.

Specifically, when playing the live stream, the client may pre-buffer a to-be-played live stream within a period of time after a current playback time, and parse this part of the to-be-played live stream in advance, to obtain the to-be-played video stream, the to-be-played audio stream, the to-be-displayed subtitle, and the display time corresponding to the to-be-displayed subtitle that are included in the to-be-played live stream; and then when it is determined that the playback condition of the to-be-played live stream is met, synchronously play the to-be-played video stream and the to-be-played audio stream obtained through decoding, and display the to-be-displayed subtitle based on the display time.

For example, duration of the to-be-played live stream pre-buffered by the client is 5 s, and the current playback time is t. In this case, a to-be-played live stream within t to t+5 s is pre-buffered, and is parsed in advance, to determine, according to a display time of the to-be-displayed subtitle in a parsing result, whether the to-be-displayed subtitle needs to be displayed in advance, thereby reducing a delay between the live subtitle and a live video picture or an audio in a process in which the user watches the livestreaming in real time.

Further, because duration of the to-be-played live stream pre-buffered by the client is limited, after this part of the to-be-played live stream is played, a new to-be-played live stream needs to be further buffered. For example, the client pre-buffers the to-be-played live stream within t to t+5 s, and needs to buffer a to-be-played live stream within t+5 s to t+8 s after playing the to-be-played live stream within t to t+3 s, that is, needs to obtain the to-be-played live stream within t+5 s to t+8 s from the livestreaming server.

Therefore, the livestreaming server can pre-determine the to-be-played live stream buffered by the client, determine a generation time (a playback time) corresponding to the buffered to-be-played live stream, then obtain, according to a live stream identifier and the generation time that are corresponding to the buffered to-be-played live stream, an initial live stream corresponding to the live stream identifier within a period of time after the generation time, process the initial live stream, generate a to-be-pushed live stream including subtitle information, and push the to-be-pushed live stream to the client.

Based on this, in the process in which the user watches the livestreaming in real time by using the client, the client pre-buffers the to-be-played live stream within the period of time after the current playback time, and parses this part of the to-be-played live stream in advance. Similarly, the livestreaming server can also pre-determine the to-be-played live stream buffered by the client, determine the initial live stream according to the buffered to-be-played live stream, and perform parsing processing. Although it takes particular duration for the livestreaming server to perform parsing processing on the initial live stream and for the client to perform parsing processing on the to-be-played live stream, which causes a livestreaming delay, in the embodiment of the application, a process of the livestreaming server performing parsing processing on the initial live stream and a process of the client performing parsing processing on the to-be-played live stream are executed in parallel. In addition, the client can determine, according to the display time of the to-be-displayed subtitle in the parsing result, whether the to-be-displayed subtitle needs to be displayed in advance, thereby reducing a delay between the live subtitle and a live video picture or an audio in the process in which the user watches the livestreaming in real time.
Step 204: Perform speech recognition on the audio stream to generate the corresponding recognition text, and determine time interval information between a generation time of the recognition text and a reception time of the audio stream.

Specifically, after decoding the initial live stream to obtain the audio stream and the first video stream, the livestreaming server may perform speech recognition on the audio stream to generate the corresponding recognition text, and then may use the recognition text as the subtitle information for adding to the first video stream to generate the second video stream, so that the client configured to watch the live stream can display the subtitle information for the user in a process of playing the second video stream after obtaining the second video stream.

However, in actual application, after the livestreaming server obtains the audio stream through decoding, it often takes particular duration to perform speech recognition on the audio stream. In this case, there is a time difference between the generation time of the recognition text and a time of receiving the audio stream, that is, receiving the initial live stream. If the time difference is not considered, and only the recognition text and the initial live stream are pushed to the client, there may be a case of the recognition text being out of synchronous with a video picture or a sound when the client displays the recognition text.

In the embodiment of the application, after a complete recognition text is recognized, to avoid out-of-synchronization between the recognition text and the video picture or the sound, it is required to determine duration consumed for generating the recognition text, that is, a time interval between the generation time of the recognition text and the time of receiving the audio stream by the livestreaming server, so that the client can determine, according to the time interval, how long the recognition text needs to be displayed in advance after the recognition text is obtained.

In a specific implementation, after obtaining the audio stream through decoding, the livestreaming server may divide the audio stream according to frequency spectrum information corresponding to the audio stream to generate at least two audio clips.

Correspondingly, the performing speech recognition on the audio stream to generate the corresponding recognition text, and determining time interval information between a generation time of the recognition text and a reception time of the audio stream includes:
performing speech recognition on a target audio clip to generate a corresponding recognition text, wherein the target audio clip is one of the at least two audio clips; and
determining a generation time of the recognition text, and determining time interval information between the generation time and a reception time of the target audio clip.

Specifically, when speech recognition is performed on the audio stream, if a recognized audio stream is a complete statement, accuracy of a recognition result can be ensured. Based on this, in the embodiment of the application, the audio stream can be first divided according to the frequency spectrum information corresponding to the audio stream, to generate the at least two audio clips. For example, according to the frequency spectrum information, an audio stream between any two adjacent points whose frequency spectrum value is 0 (indicating pause) is used as one audio clip. Then, speech recognition is performed on each audio clip to generate a corresponding recognition text, a generation time of the recognition text is determined, and time interval information between the generation time and a reception time of each audio clip (the reception time of the audio stream or the initial live stream) is determined.

Alternatively, the performing speech recognition on the audio stream to generate the corresponding recognition text, and determining time interval information between a generation time of the recognition text and a reception time of the audio stream includes:
splitting the audio stream according to a preset recognition window to generate at least one audio clip;
performing speech recognition on a target audio clip to generate a corresponding recognition text, wherein the target audio clip is one of the at least one audio clip; and
determining a generation time of the recognition text, and determining time interval information between the generation time and the reception time of the audio stream.

Specifically, in a process of performing speech recognition on the audio stream, the preset recognition window is usually used. A window length of the preset recognition window may be 0.5 s to 1 s, and by using the preset recognition window to perform speech recognition on the audio stream, a single word in the audio stream can be recognized. Alternatively, a window length of the preset recognition window may be 1 s to 5 s, and by using the preset recognition window to perform speech recognition on the audio stream, a complete sentence in the audio stream can be recognized. A specific window length may be determined according to an actual requirement. This is not limited herein.

Speech recognition is performed on the audio stream according to the preset recognition window. Specifically, the audio stream is split according to the preset recognition window to generate the at least one audio clip, speech recognition is performed on each audio clip to generate the corresponding recognition text, then, the generation time of the recognition text is determined, and the time interval information between the generation time and the reception time of the audio stream is determined.

In addition, in the embodiment of the application, the livestreaming server includes a transcoding module and a speech recognition service module. Therefore, in terms of decoding the received initial live stream to generate the audio stream and the first video stream, specifically, the received initial live stream is decoded by using the transcoding module to generate the audio stream and the first video stream. In terms of performing speech recognition on the audio stream to generate the corresponding recognition text, specifically, speech recognition is performed on the audio stream by using the speech recognition service module to generate the corresponding recognition text.

The transcoding module transmits the audio stream to the speech recognition service module by using a data transmission channel.

Specifically, the data transmission channel may be a GRPC.

Further, the performing speech recognition on the audio stream by using the speech recognition service module to generate the corresponding recognition text includes:
splitting the audio stream according to a preset recognition window by using the speech recognition service module to generate at least one audio clip; and
performing speech recognition on a first audio clip to generate a corresponding first recognition text, and returning the first recognition text to the transcoding module, wherein the first audio clip is one of the at least one audio clip.

Specifically, as described above, in the process of performing speech recognition on the audio stream, the preset recognition window is usually used. Similarly, by using the speech recognition service module to perform speech recognition on the audio stream, the preset recognition window may also be used to perform speech recognition on the audio stream according to the preset recognition window. Specifically, the audio stream is split according to the preset recognition window to generate the at least one audio clip, speech recognition is performed on each audio clip to generate the corresponding recognition text, then, the generation time of the recognition text is determined, and the time interval information between the generation time and the reception time of the audio stream is determined.

A window length of the preset recognition window may be 0.5 s to 1 s, and by using the preset recognition window to perform speech recognition on the audio stream, a single word in the audio stream can be recognized. Alternatively, a window length of the preset recognition window may be 1 s to 5 s, and by using the preset recognition window to perform speech recognition on the audio stream, a complete sentence in the audio stream can be recognized. A specific window length may be determined according to an actual requirement. This is not limited herein.
Step 206: Use the recognition text as the subtitle information, and add the subtitle information and the time interval information to the first video stream to generate the second video stream.

Specifically, after the recognition text is generated and the time interval information between the generation time of the recognition text and the reception time of the audio stream is determined, the recognition text can be used as the subtitle information, and the subtitle information and the time interval information are added to the first video stream to generate the second video stream. The subtitle information may be written to the first video stream in a form of SEI, to generate the second video stream.

In a specific implementation, a text type of the recognition text may be further determined according to a text length and/or a text semantic meaning of the recognition text.

Correspondingly, the using the recognition text as the subtitle information, and adding the subtitle information and the time interval information to the first video stream includes:
determining a target video frame in the first video stream according to the generation time; and
using the recognition text as the subtitle information, and using the subtitle information, the time interval information, and the text type as video frame information of the target video frame for adding to the first video stream.

Specifically, as described above, in the process of performing speech recognition on the audio stream, the preset recognition window is usually used. A window length of the preset recognition window may be 0.5 s to 1 s, and by using the preset recognition window to perform speech recognition on the audio stream, a single word in the audio stream can be recognized. Alternatively, a window length of the preset recognition window may be 1 s to 5 s, and by using the preset recognition window to perform speech recognition on the audio stream, a complete sentence in the audio stream can be recognized.

Therefore, after the recognition text is generated in the embodiment of the application, the text type of the recognition text may be further determined according to the text length and/or the text semantic meaning of the recognition text. In actual application, the text type includes but is not limited to a word, a phrase, a sentence, and the like. The text semantic meaning is used to determine whether the recognition text can express a complete semantic meaning. If the recognition text can express a complete semantic meaning, the text type of the recognition text can be determined as a sentence type. If the recognition text cannot express a complete semantic meaning, the text type of the recognition text is a phrase type when the text length of the recognition text is greater than or equal to two words, or the text type of the recognition text is a word type if the text length is equal to 1.

After the text type of the recognition text is determined, the target video frame in the first video stream may be determined according to the generation time of the recognition text, the recognition text is used as the subtitle information, and the subtitle information, the time interval information, and the text type are used as the video frame information of the target video frame and added to the first video stream.

In actual application, a last video frame in a video clip corresponding to the target audio clip may be usually used as the target video frame, and the subtitle information, the time interval information, and the text type are used as the video frame information of the target video frame and added to the first video stream, to generate the second video stream. In this case, after obtaining the second video stream, the client can determine to-be-displayed subtitle information according to the text type, and usually, preferentially select sentence-type subtitle information for display, to ensure a watching effect of the live subtitle.

In addition, in the embodiment of the application, after the splitting the audio stream according to a preset recognition window by using the speech recognition service module to generate at least one audio clip and performing speech recognition on a first audio clip to generate a corresponding first recognition text, the using the recognition text as the subtitle information, and adding the subtitle information and the time interval information to the first video stream includes:

The transcoding module determines a first target video frame in the first video stream according to a generation time of the first recognition text; and
uses the first recognition text as first subtitle information, and uses the first subtitle information and time interval information between the generation time of the first recognition text and the reception time of the audio stream as video frame information of the first target video frame for adding to the first video stream.

Specifically, when splitting the audio stream into one or the at least two audio clips, the speech recognition service module may sequentially perform speech recognition on each audio clip, and after generating a recognition text corresponding to any audio clip, may return the recognition text to the transcoding module. The transcoding module determines the target video frame (which is usually a last video frame of a video clip corresponding to the any audio clip) in the first video stream according to a generation time of the recognition text, uses the text recognition as subtitle information, and uses the subtitle information and time interval information between the generation time of the recognition text and the reception time of the audio stream as the video frame information of the target video frame for adding to the first video stream.

Further, the performing speech recognition on the audio stream by using the speech recognition service module to generate the corresponding recognition text includes:
performing speech recognition on a second audio clip that is in the at least two audio clips and that is adjacent to the first audio clip, to generate a corresponding second recognition text, and returning the first recognition text and the second recognition text to the transcoding module.

Correspondingly, the using the recognition text as the subtitle information, and adding the subtitle information and the time interval information to the first video stream includes:

The transcoding module determines a second target video frame in the first video stream according to a generation time of the second recognition text; and
uses the first recognition text and the second recognition text as second subtitle information, and uses the second subtitle information and time interval information between the generation time of the second recognition text and the reception time of the audio stream as video frame information of the second target video frame for adding to the first video stream.

Specifically, as described above, when splitting the audio stream into the at least two audio clips, the speech recognition service module may first perform speech recognition on the first audio clip in the at least two audio clips to generate the corresponding first recognition text. The transcoding module uses the first recognition text as the subtitle information, and uses the subtitle information and the time interval information between the generation time of the first recognition text and the reception time of the audio stream as the video frame information of the first target video frame (which is usually a last video frame of a video clip corresponding to the first audio clip) for adding to the first video stream.

Then, speech recognition may be performed on the second audio clip that is in the at least two audio clips and that is adjacent to the first audio clip, to generate the corresponding second recognition text. The transcoding module uses the first recognition text and the second recognition text as the subtitle information, and uses the subtitle information and the time interval information between the generation time of the second recognition text and the reception time of the audio stream as the video frame information of the second target video frame (which is usually a last video frame of a video clip corresponding to the second audio clip) for adding to the first video stream; and so on.

After obtaining the first recognition text, the speech recognition service module may temporarily store the first recognition text. After the second recognition text is obtained through recognition, because the first audio clip is adjacent to the second audio clip, the first recognition text and the second recognition text can be returned together as the subtitle information of the video stream, so that the speech recognition service module can reuse the buffer to improve accuracy of a recognition result of the subtitle information.
Step 208: Encode the second video stream and the audio stream to generate a to-be-pushed live stream, and return the to-be-pushed live stream to the client.

Specifically, after generating the second video stream, the livestreaming server may encode the second video stream and the audio stream to generate the to-be-pushed live stream, and may push the to-be-pushed live stream to the client of the user when the user has a watching requirement for the livestreaming.

In a specific implementation, the client decodes the to-be-pushed live stream to generate a corresponding audio stream, a video stream, and the video frame information of the target video frame in the video stream, where the video frame information includes the subtitle information, the time interval information, and the text type;
when it is determined that the text type is a target type, determines a display time of the subtitle information according to a play back time of the target video frame and the time interval information;
determines, according to the display time, at least two video frames that are in the video stream and that are used to display the subtitle information, where playback times of the at least two video frames are earlier than the play back time of the target video frame; and
when it is determined that a playback condition of the to-be-pushed live stream is met, synchronously plays the video stream and the audio stream, and displays the subtitle information in the at least two video frames and the target video frame based on the display time.

Specifically, as described above, when playing the live stream, the client may pre-pull, from the livestreaming server, a to-be-pushed live stream of specific duration after a current playback time, and buffer the to-be-pushed live stream; then, decode the buffered to-be-pushed live stream in advance, to obtain subtitle information corresponding to a target video frame in the to-be-pushed live stream, a text type of the subtitle information, and time interval information between a generation time of the subtitle information and the reception time of the audio stream by the livestreaming server; when it is determined according to the text type that the subtitle information belongs to a target text type, namely, the sentence type, determine a display time of the subtitle information according to the time interval information between the generation time of the subtitle information carried in the to-be-pushed live stream and the reception time of the audio stream by the livestreaming server in combination with a play back time of the target video frame; afterwards determine, according to the display time, another video frame that is used to display the subtitle information and that is located before the target video frame in the to-be-pushed live stream; and when it is determined that a playback condition of the to-be-pushed live stream is met, synchronously play the video stream and the audio stream obtained through decoding, and display the subtitle information in the determined video frame and the target video frame based on the display time.

For example, a current time point is t. In a process of playing the live stream by the client, the client pre-buffers a to-be-pushed live stream that needs to be played within t to t+5 s, and then obtains, through decoding, subtitle information carried in the to-be-pushed live stream. If a decoding result includes recognition texts corresponding to video frames at five time points t+1 s, t+2 s, t+3 s, t+4 s, and t+5 s, and a text type of the recognition text corresponding to the time point t+5 s is the sentence type, the recognition text may be preferentially displayed. In this case, time interval information corresponding to the recognition text can be determined. If it is determined that a time interval between a generation time of the recognition text and the reception time of the audio stream is 4 s, and it is determined that a time interval between the generation time of the recognition text and the video frame at the time point t+5 s is 1 s, it indicates that the subtitle information (the recognition text) needs to be displayed in advance by 3 seconds, and it also indicates that the online streamer expresses a complete sentence from t+3 s to t+5 s. Therefore, when the to-be-pushed live stream at t+3 s is started to be played, the subtitle information may be simultaneously displayed, and ends displaying at t+5 s, to display a complete subtitle in advance, and avoid a delay between the subtitle and a video picture or a sound. Displaying of the subtitle information stops until it is detected that other subtitle information needs to be displayed.

The embodiments of the application implement the livestreaming data processing method and system. The livestreaming data processing method includes: decoding a received initial live stream to generate an audio stream and a first video stream; performing speech recognition on the audio stream to generate a corresponding recognition text, and determining time interval information between a generation time of the recognition text and a reception time of the audio stream; using the recognition text as subtitle information, and adding the subtitle information and the time interval information to the first video stream to generate a second video stream; and encoding the second video stream and the audio stream to generate a to-be-pushed live stream, and returning the to-be-pushed live stream to a client.

In the embodiments of the application, the livestreaming server performs speech recognition on the audio stream to generate the corresponding recognition text, and records the time interval between the generation time of the recognition text and the time of receiving the audio stream. The time interval may be used to represent duration consumed by the livestreaming server to perform speech recognition on the audio stream in the initial live stream after receiving the initial live stream. Therefore, after the recognition text and the time interval information are added to the video stream and returned to the client, the client can obtain, through pre-parsing, the subtitle information carried in the to-be-pushed live stream, and determine the display time of the subtitle information according to the time interval information between the generation time of the subtitle information and the time of receiving the audio stream by the livestreaming server, that is, determine the display time of the complete subtitle corresponding to the to-be-pushed live stream, to display the complete subtitle in advance based on the display time. This helps reduce costs of generating the subtitle, improve efficiency of generating the subtitle, and further avoid out-of-synchronization between the subtitle and a video picture or an audio, thereby helping meet a need of the user for watching the live subtitle in a process of watching the livestreaming, and helping improve experience of the user in watching the livestreaming.

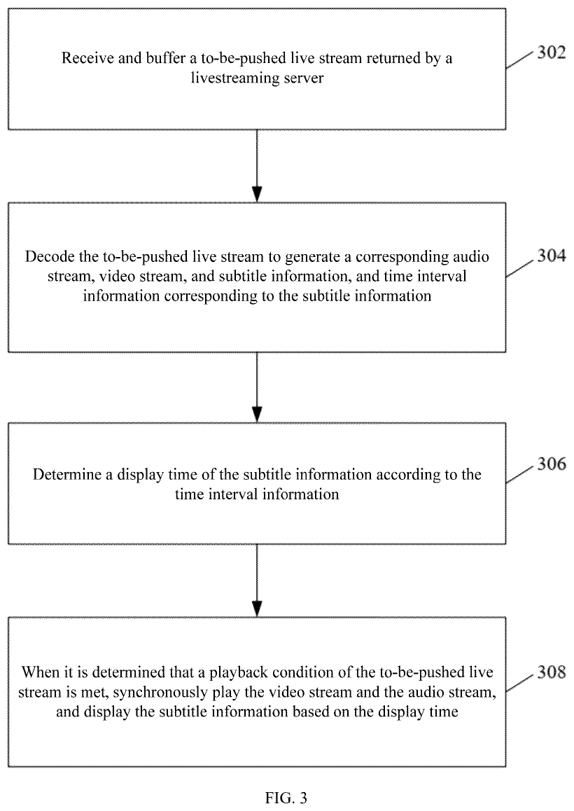

FIG. 3 is a flowchart of another livestreaming data processing method according to an embodiment of the application. The another livestreaming data processing method includes the following steps:
Step 302: Receive and buffer a to-be-pushed live stream returned by a livestreaming server.
Step 304: Decode the to-be-pushed live stream to correspondingly generate an audio stream, a video stream, subtitle information, and time interval information corresponding to the subtitle information, where the time interval information is determined by the livestreaming server according to a generation time of the subtitle information and a reception time of the audio stream.
Step 306: Determine a display time of the subtitle information according to the time interval information.
Step 308: When it is determined that a playback condition of the to-be-pushed live stream is met, synchronously play the video stream and the audio stream, and display the subtitle information based on the display time.

Specifically, an online streamer performs livestreaming by using an intelligent terminal, and pushes a generated initial live stream to the livestreaming server. The livestreaming server decodes the received initial live stream to generate an audio stream and a first video stream; then performs speech recognition on the audio stream to generate a corresponding recognition text, and determines time interval information between a generation time of the recognition text and a reception time of the audio stream; afterward uses the recognition text as subtitle information, and adds the subtitle information and the time interval information to the first video stream to generate a second video stream; and furthermore encodes the second video stream and the audio stream to generate a to-be-pushed live stream. When a user watches the livestreaming of the online streamer, the livestreaming server may push the to-be-pushed live stream to a client of the user.

In a process of playing the live stream for the user by the client, the client may pre-pull a to-be-pushed live stream of specific duration from the livestreaming server and buffer the to-be-pushed live stream. In this case, the client may decode the buffered to-be-pushed live stream in advance, to obtain subtitle information included in the to-be-pushed live stream; then may determine a display time of the subtitle information according to time interval information between a generation time of the subtitle information carried in the to-be-pushed live stream and the reception time of the audio stream by the livestreaming server; and when it is determined that a playback condition of the to-be-pushed live stream is met, synchronously plays a video stream and the audio stream obtained through decoding, and displays the subtitle information based on the display time.

In the embodiment of the application, in the foregoing processing manner, the client can obtain, through pre-parsing, the subtitle information carried in the to-be-pushed live stream, and determine the display time of the subtitle information according to the time interval information between the generation time of the subtitle information and the time of receiving the audio stream by the livestreaming server, that is, determine a display time of a complete subtitle corresponding to the to-be-pushed live stream, to display the complete subtitle in advance based on the display time. This helps reduce costs of generating the subtitle, improve efficiency of generating the subtitle, and further avoid out-of-synchronization between the subtitle and a video picture or an audio, thereby helping meet a need of the user for watching the live subtitle in a process of watching the livestreaming, and helping improve experience of the user in watching the livestreaming.

The foregoing describes a schematic solution of the another livestreaming data processing method in the embodiment. It should be noted that the technical solution of the livestreaming data processing method and the technical solution of the foregoing livestreaming data processing method belong to a same concept. For details not described in detail in the technical solution of the livestreaming data processing method, refer to the descriptions of the technical solution of the foregoing livestreaming data processing method.

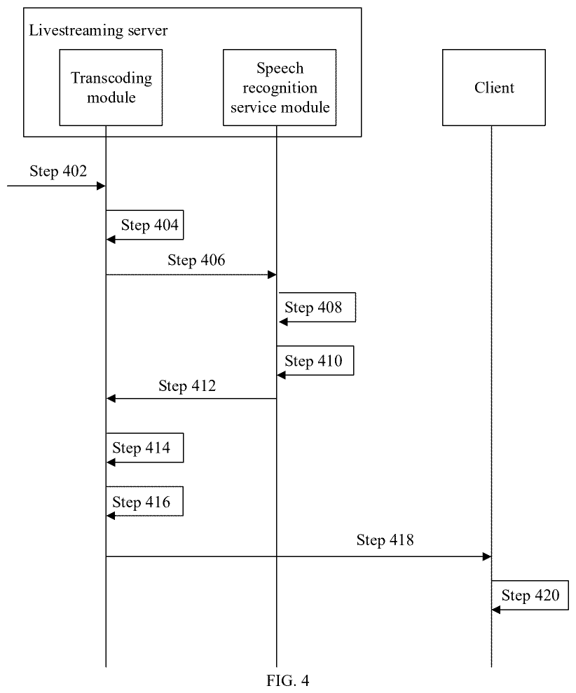

Referring to FIG. 4, the livestreaming data processing method is further described by using an example in which the livestreaming data processing method provided in the embodiment of the application is applied to the livestreaming field. FIG. 4 is a schematic diagram of interaction in which a livestreaming data processing method according to an embodiment of the application is applied to the livestreaming field, specifically including the following steps.
Step 402: A transcoding module receives an initial live stream of an online streamer.
Step 404: The transcoding module decodes the initial live stream to generate an audio stream and a first video stream.
Step 406: The transcoding module transmits the audio stream to a speech recognition service module by using a GRPC.
Step 408: The speech recognition service module performs speech recognition on the audio stream to generate a corresponding recognition text.
Step 410: The speech recognition service module determines a generation time of the recognition text, determines time interval information between the generation time and a reception time of the audio stream, and determines a text type of the recognition text according to a text length and/or a text semantic meaning of the recognition text.
Step 412: The speech recognition service module transmits the recognition text, the text type, and the time interval information to the transcoding module by using the GRPC.
Step 414: The transcoding module uses the recognition text as subtitle information, and adds the subtitle information, the time interval information, and the text type to the first video stream to generate a second video stream.
Step 416: The transcoding module encodes the second video stream and the audio stream to generate a to-be-pushed live stream.
Step 418: A client pulls the to-be-pushed live stream from a livestreaming server.

The livestreaming server includes the transcoding module and the speech recognition service module.
Step 420: The client decodes the to-be-pushed live stream to correspondingly generate the audio stream, the second video stream, the subtitle information, and the time interval information, determines a display time of the subtitle information according to the time interval information, and when it is determined that a playback condition of the to-be-pushed live stream is met, synchronously plays the second video stream and the audio stream, and displays the subtitle information based on the display time.

In the embodiment of the application, in the foregoing processing manner, the client can obtain, through pre-parsing, the subtitle information carried in the to-be-pushed live stream, and determine the display time of the subtitle information according to the time interval information between the generation time of the subtitle information and the time of receiving the audio stream by the livestreaming server, that is, determine a display time of a complete subtitle corresponding to the to-be-pushed live stream, to display the complete subtitle in advance based on the display time. This helps reduce costs of generating the subtitle, improve efficiency of generating the subtitle, and further avoid out-of-synchronization between the subtitle and a video picture or an audio, thereby helping meet a need of a user for watching a live subtitle in a process of watching livestreaming, and helping improve experience of the user in watching the livestreaming.

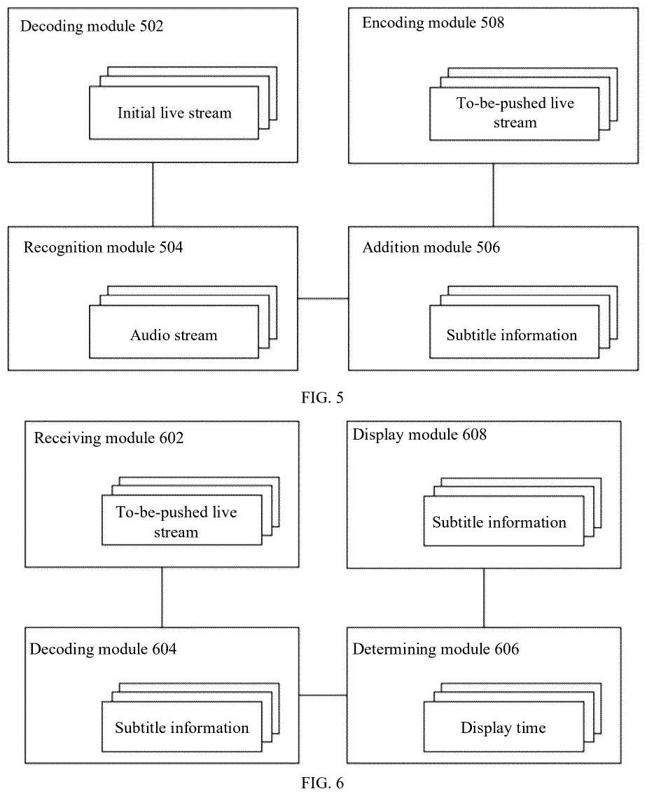

Corresponding to the foregoing method embodiments, the application further provides an embodiment of a livestreaming data processing apparatus. FIG. 5 is a schematic diagram of a structure of a livestreaming data processing apparatus according to an embodiment of the application. As shown in FIG. 5, the apparatus includes:
a decoding module 502, configured to decode a received initial live stream to generate an audio stream and a first video stream;
a recognition module 504, configured to perform speech recognition on the audio stream to generate a corresponding recognition text, and determine time interval information between a generation time of the recognition text and a reception time of the audio stream;
an addition module 506, configured to use the recognition text as subtitle information, and add the subtitle information and the time interval information to the first video stream to generate a second video stream; and
an encoding module 508, configured to encode the second video stream and the audio stream to generate a to-be-pushed live stream, and return the to-be-pushed live stream to a client.

Optionally, the decoding module 502 is further configured to:
determine a to-be-played live stream buffered by the client, and determine a generation time corresponding to the to-be-played live stream; and
obtain, according to a live stream identifier and the generation time that are corresponding to the to-be-played live stream, an initial live stream corresponding to the live stream identifier in a preset time interval, and decode the initial live stream, where the preset time interval is later than the generation time.

Optionally, the client decodes the to-be-played live stream to correspondingly generate a to-be-played audio stream, a to-be-played video stream, a to-be-displayed subtitle, and a display time corresponding to the to-be-displayed subtitle; and
when it is determined that a playback condition of the to-be-played live stream is met, synchronously plays the to-be-played video stream and the to-be-played audio stream, and displays the to-be-displayed subtitle based on the display time.

Optionally, the livestreaming data processing apparatus further includes a determining module, configured to:
determine a text type of the recognition text according to a text length and/or a text semantic meaning of the recognition text.

Correspondingly, the addition module 506 is further configured to:
determine a target video frame in the first video stream according to the generation time; and
use the recognition text as the subtitle information, and use the subtitle information, the time interval information, and the text type as video frame information of the target video frame for adding to the first video stream.

Optionally, the client decodes the to-be-pushed live stream to generate a corresponding audio stream, a video stream, and the video frame information of the target video frame in the video stream, where the video frame information includes the subtitle information, the time interval information, and the text type;
when it is determined that the text type is a target type, determines a display time of the subtitle information according to a play back time of the target video frame and the time interval information;
determines, according to the display time, at least two video frames that are in the video stream and that are used to display the subtitle information, where play back times of the at least two video frames are earlier than the play back time of the target video frame; and
when it is determined that a playback condition of the to-be-pushed live stream is met, synchronously plays the video stream and the audio stream, and displays the subtitle information in the at least two video frames and the target video frame based on the display time.

Optionally, the livestreaming data processing apparatus further includes a division module, configured to:
divide the audio stream according to frequency spectrum information corresponding to the audio stream to generate at least two audio clips.

Correspondingly, the recognition module 504 is further configured to:
perform speech recognition on a target audio clip to generate a corresponding recognition text, where the target audio clip is one of the at least two audio clips; and
determine a generation time of the recognition text, and determine time interval information between the generation time and a reception time of the target audio clip.

Optionally, the recognition module 504 is further configured to:
split the audio stream according to a preset recognition window to generate at least one audio clip;
perform speech recognition on a target audio clip to generate a corresponding recognition text, where the target audio clip is one of the at least one audio clip; and
determine a generation time of the recognition text, and determine time interval information between the generation time and the reception time of the audio stream.

Optionally, the decoding module 502 is further configured to:
decode the received initial live stream by using a transcoding module to generate the audio stream and the first video stream.

Correspondingly, the recognition module 504 is further configured to:
perform speech recognition on the audio stream by using a speech recognition service module to generate the corresponding recognition text.

Optionally, the recognition module 504 is further configured to:
split the audio stream according to a preset recognition window by using the speech recognition service module to generate at least one audio clip; and
perform speech recognition on a first audio clip to generate a corresponding first recognition text, and return the first recognition text to the transcoding module, where the first audio clip is one of the at least one audio clip.

Optionally, the addition module 506 is further configured to:

The transcoding module determines a first target video frame in the first video stream according to a generation time of the first recognition text; and
uses the first recognition text as first subtitle information, and uses the first subtitle information and time interval information between the generation time of the first recognition text and the reception time of the audio stream as video frame information of the first target video frame for adding to the first video stream.

Optionally, the recognition module 504 is further configured to:
perform speech recognition on a second audio clip that is in the at least two audio clips and that is adjacent to the first audio clip, to generate a corresponding second recognition text, and return the first recognition text and the second recognition text to the transcoding module.

Optionally, the addition module 506 is further configured to:
determine a second target video frame in the first video stream according to a generation time of the second recognition text; and
use the first recognition text and the second recognition text as second subtitle information, and use the second subtitle information and time interval information between the generation time of the second recognition text and the reception time of the audio stream as video frame information of the second target video frame for adding to the first video stream.

Optionally, the livestreaming data processing apparatus further includes a transmission module, configured to:
transmit the audio stream to the speech recognition service module by using a data transmission channel.

The foregoing describes a schematic solution of the livestreaming data processing apparatus in the embodiment. It should be noted that the technical solution of the livestreaming data processing apparatus and the technical solution of the foregoing livestreaming data processing method belong to a same concept. For details not described in detail in the technical solution of the livestreaming data processing apparatus, refer to the descriptions of the technical solution of the foregoing livestreaming data processing method.

Corresponding to the foregoing method embodiments, the application further provides an embodiment of a livestreaming data processing apparatus. FIG. 6 is a schematic diagram of a structure of another livestreaming data processing apparatus according to an embodiment of the application. As shown in FIG. 6, the apparatus includes:
a receiving module 602, configured to receive and buffer a to-be-pushed live stream returned by a livestreaming server;
a decoding module 604, configured to decode the to-be-pushed live stream to generate a corresponding audio stream, video stream, and subtitle information, and time interval information corresponding to the subtitle information, where the time interval information is determined by the livestreaming server according to a generation time of the subtitle information and a reception time of the audio stream;
a determining module 606, configured to determine a display time of the subtitle information according to the time interval information; and
a display module 608, configured to: when it is determined that a playback condition of the to-be-pushed live stream is met, synchronously play the video stream and the audio stream, and display the subtitle information based on the display time.

The foregoing describes a schematic solution of the another livestreaming data processing apparatus in the embodiment. It should be noted that the technical solution of the livestreaming data processing apparatus and the technical solution of the foregoing another livestreaming data processing method belong to a same concept. For details not described in detail in the technical solution of the livestreaming data processing apparatus, refer to the descriptions of the technical solution of the foregoing another livestreaming data processing method.

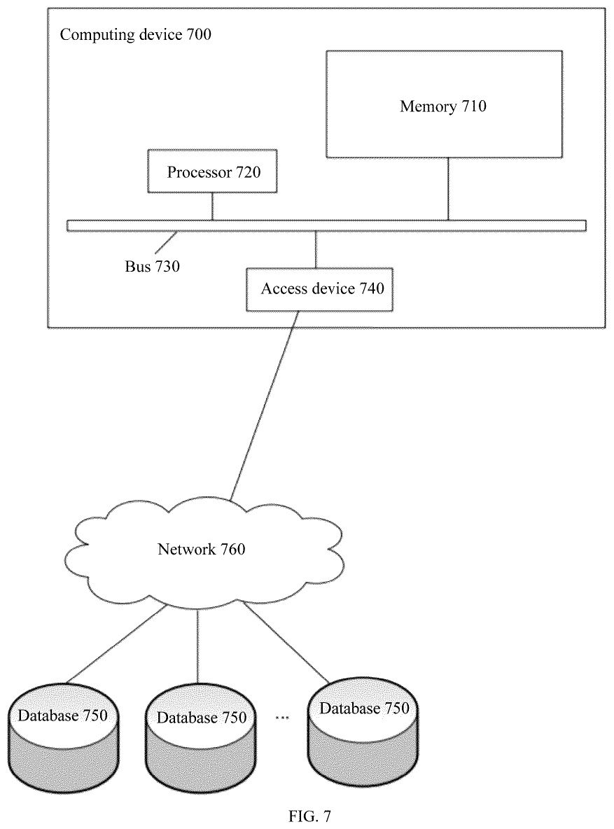

FIG. 7 is a block diagram of a structure of a computing device 700 according to an embodiment of the application. Components of the computing device 700 include but are not limited to a memory 710 and a processor 720. The processor 720 is connected to the memory 710 by using a bus 730. A database 750 is configured to store data.

The computing device 700 further includes an access device 740. The access device 740 enables the computing device 700 to perform communication by using one or more networks 760. Examples of these networks include a public switched telephone network (PSTN), a local area network (LAN), a wide area network (WAN), a private area network (PAN), or a combination of communication networks such as the Internet. The access device 740 may include one or more of any type of wired or wireless network interface (for example, a network interface card (NIC)), such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In an embodiment of the application, the foregoing components of the computing device 700 and other components not shown in FIG. 7 may be connected to each other, for example, by using a bus. It should be understood that the block diagram of the structure of the computing device shown in FIG. 7 is merely used as an example instead of a limitation on the scope of the application. A person skilled in the art can add or replace other components as required.

The computing device 700 may be any type of stationary or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smartwatch or smart glasses), or another type of mobile device, or a stationary computing device such as a desktop computer or a PC. The computing device 700 may alternatively be a mobile or stationary server.

The processor 720 is configured to execute the following computer-executable instructions. The processor is configured to execute the computer-executable instructions. When the processor executes the computer-executable instructions, the steps of the livestreaming data processing method are implemented.

The foregoing describes a schematic solution of the computing device in the embodiment. It should be noted that the technical solution of the computing device and the technical solution of the foregoing livestreaming data processing method belong to a same concept. For details not described in detail in the technical solution of the computing device, refer to the descriptions of the technical solution of the foregoing livestreaming data processing method.

An embodiment of the application further provides a computer-readable storage medium, storing computer-executable instructions. When the instructions are executed by a processor, the following steps are implemented:
performing speech recognition on an audio stream to generate a corresponding recognition text, and determining time interval information between a generation time of the recognition text and a reception time of the audio stream;
using the recognition text as subtitle information, and adding the subtitle information and the time interval information to a first video stream to generate a second video stream; and
encoding the second video stream and the audio stream to generate a to-be-pushed live stream, and returning the to-be-pushed live stream to a client.

Alternatively, the following steps are implemented:
receiving and buffering a to-be-pushed live stream returned by a livestreaming server;
decoding the to-be-pushed live stream to generate a corresponding audio stream, video stream, and subtitle information, and time interval information corresponding to the subtitle information, where the time interval information is determined by the livestreaming server according to a generation time of the subtitle information and a reception time of the audio stream;
determining a display time of the subtitle information according to the time interval information; and
when it is determined that a playback condition of the to-be-pushed live stream is met, synchronously playing the video stream and the audio stream, and displaying the subtitle information based on the display time.

The foregoing describes a schematic solution of the computer-readable storage medium in the embodiment. It should be noted that the technical solution of the storage medium and the technical solution of the foregoing livestreaming data processing method belong to a same concept. For details not described in detail in the technical solution of the storage medium, refer to the descriptions of the technical solution of the foregoing livestreaming data processing method.

The foregoing describes specific embodiments of the application. Other embodiments fall within the scope of the appended claims. In some cases, actions or steps recorded in the claims may be performed in an order different from that in the embodiments and desired results may still be achieved. In addition, processes depicted in the accompanying drawings do not necessarily require a specific order or a sequential order shown to achieve the desired results. In some implementations, multitasking and parallel processing are also possible or may be advantageous.

The computer instructions include computer program code, and the computer program code may be in a source code form, an object code form, an executable file form, an intermediate form, or the like. The computer-readable medium may include: any entity or apparatus capable of carrying the computer program code, a recording medium, a USB flash drive, a removable hard disk, a magnetic disk, a compact disc, a computer memory, a read-only memory (ROM), a random access memory (RAM), an electrical carrier signal, a telecommunication signal, a software distribution medium, or the like. It should be noted that the content included in the computer-readable medium can be appropriately added or deleted depending on requirements of the legislation and patent practice in a jurisdiction. For example, in some jurisdictions, according to the legislation and patent practice, the computer-readable medium does not include an electrical carrier signal or a telecommunication signal.

It should be noted that, for ease of description, the foregoing method embodiments are described as a combination of a series of actions. However, a person skilled in the art should understand that embodiments of the application are not limited to the described action sequence, because according to embodiments of the application, some steps may be performed in another sequence or simultaneously. In addition, a person skilled in the art should also be aware that the embodiments described in the specification are all preferred embodiments, and used actions and means are not necessarily mandatory to the embodiments of the application.

In the foregoing embodiments, the descriptions of the embodiments have respective focuses. For a part that is not described in detail in an embodiment, refer to related descriptions in other embodiments.

The preferred embodiments of the application disclosed above are merely intended to help describe the application. In the optional embodiments, not all details are described in detail, and the present invention is not limited to only the specific implementations. Clearly, many modifications and changes may be made based on the content of embodiments of the application. The embodiments are selected and specifically described in the application to better explain the principle and the actual applications of embodiments of the application, so that a person skilled in the art can better understand and use the application. The application is only subject to the claims and a full scope and equivalents thereof.

1. A livestreaming data processing method, comprising:
decoding a received initial live stream to generate an audio stream and a first video stream;
performing speech recognition on the audio stream to generate a corresponding recognition text, and determining time interval information between a generation time of the recognition text and a reception time of the audio stream;
using the recognition text as subtitle information, and adding the subtitle information and the time interval information to the first video stream to generate a second video stream; and
encoding the second video stream and the audio stream to generate a to-be-pushed live stream, and returning the to-be-pushed live stream to a client.

2. The livestreaming data processing method according to claim 1, wherein the decoding a received initial live stream comprises:
determining a to-be-played live stream buffered by the client, and determining a generation time corresponding to the to-be-played live stream; and
obtaining, according to a live stream identifier corresponding to the to-be-played live stream and the generation time corresponding to the to-be-played live stream, an initial live stream corresponding to the live stream identifier in a preset time interval, and decoding the initial live stream, wherein the preset time interval is later than the generation time corresponding to the to-be-played live stream.

3. The livestreaming data processing method according to claim 2, wherein the client is configured to:
decode the to-be-played live stream to correspondingly generate a to-be-played audio stream, a to-be-played video stream, a to-be-displayed subtitle, and a display time corresponding to the to-be-displayed subtitle; and
when determining a playback condition of the to-be-played live stream is met, synchronously play the to-be-played video stream and the to-be-played audio stream, and displays the to-be-displayed subtitle based on the display time.

4. The livestreaming data processing method according to claim 1, further comprising:
determining a text type of the recognition text according to a text length and/or a text semantic meaning of the recognition text; and
correspondingly, the using the recognition text as subtitle information, and adding the subtitle information and the time interval information to the first video stream comprises:
determining a target video frame in the first video stream according to the generation time of the recognition text; and
using the recognition text as the subtitle information, and using the subtitle information, the time interval information, and the text type as video frame information of the target video frame for adding to the first video stream.

5. The livestreaming data processing method according to claim 4, wherein the client is configured to:
decode the to-be-pushed live stream to generate a corresponding audio stream, a corresponding video stream, and the video frame information of the target video frame in the corresponding video stream, wherein the video frame information comprises the subtitle information, the time interval information, and the text type;
when determining the text type is a target type, determine a display time of the subtitle information according to a playback time of the target video frame and the time interval information;
determine at least two video frames according to the display time, wherein the at least two video frames are in the video stream and are used to display the subtitle information, and any one playback time of the at least two video frames is earlier than the playback time of the target video frame; and
when determining a playback condition of the to-be-pushed live stream is met, synchronously play the corresponding video stream and the corresponding audio stream, and display the subtitle information in the at least two video frames and the target video frame based on the display time.

6. The livestreaming data processing method according to claim 1, further comprising:
dividing the audio stream according to frequency spectrum information corresponding to the audio stream to generate at least two audio clips; and
correspondingly, the performing speech recognition on the audio stream to generate a corresponding recognition text, and determining time interval information between a generation time of the recognition text and a reception time of the audio stream comprises:
performing speech recognition on a target audio clip to generate the corresponding recognition text, wherein the target audio clip is one of the at least two audio clips; and
determining the generation time of the recognition text, and determining time interval information between the generation time of the recognition text and a reception time of the target audio clip.

7. The livestreaming data processing method according to claim 1, wherein the performing speech recognition on the audio stream to generate a corresponding recognition text, and determining time interval information between a generation time of the recognition text and a reception time of the audio stream comprises:
splitting the audio stream according to a preset recognition window to generate at least one audio clip;
performing speech recognition on a target audio clip to generate the corresponding recognition text, wherein the target audio clip is one of the at least one audio clip; and
determining a generation time of the recognition text, and determining time interval information between the generation time of the recognition text and the reception time of the audio stream.

8. The livestreaming data processing method according to claim 1, wherein the decoding a received initial live stream to generate an audio stream and a first video stream comprises:
decoding the received initial live stream by using a transcoding module to generate the audio stream and the first video stream; and
correspondingly, the performing speech recognition on the audio stream to generate a corresponding recognition text comprises:
performing speech recognition on the audio stream by using a speech recognition service module to generate the corresponding recognition text.

9. The livestreaming data processing method according to claim 8, wherein the performing speech recognition on the audio stream by using a speech recognition service module to generate the corresponding recognition text comprises:
splitting the audio stream according to a preset recognition window by using the speech recognition service module to generate at least one audio clip; and
performing speech recognition on a first audio clip to generate a corresponding first recognition text, and returning the first recognition text to the transcoding module, wherein the first audio clip is one of the at least one audio clip.

10. The livestreaming data processing method according to claim 9, wherein the using the recognition text as subtitle information, and adding the subtitle information and the time interval information to the first video stream comprises:
determining, by the transcoding module, a first target video frame in the first video stream according to a generation time of the first recognition text; and
using the first recognition text as first subtitle information, and using the first subtitle information and time interval information between the generation time of the first recognition text and the reception time of the audio stream as video frame information of the first target video frame for adding to the first video stream.

11. The livestreaming data processing method according to claim 10, wherein the performing speech recognition on the audio stream by using a speech recognition service module to generate the corresponding recognition text further comprises:
performing speech recognition on a second audio clip to generate a corresponding second recognition text, wherein the second audio clip is in at least two audio clips and is adjacent to the first audio clip, and returning the first recognition text and the second recognition text to the transcoding module.

12. The livestreaming data processing method according to claim 11, wherein the using the recognition text as subtitle information, and adding the subtitle information and the time interval information to the first video stream comprises:
determining, by the transcoding module, a second target video frame in the first video stream according to a generation time of the second recognition text; and
using the first recognition text and the second recognition text as second subtitle information, and using the second subtitle information and time interval information between the generation time of the second recognition text and the reception time of the audio stream as video frame information of the second target video frame for adding to the first video stream.

13. The livestreaming data processing method according to claim 8, further comprising:
transmitting, by the transcoding module, the audio stream to the speech recognition service module by using a data transmission channel.

14. A livestreaming data processing method, comprising:
receiving and buffering a to-be-pushed live stream returned by a livestreaming server;
decoding the to-be-pushed live stream to correspondingly generate an corresponding audio stream, a video stream, subtitle information, and time interval information corresponding to the subtitle information, wherein the time interval information is determined by the livestreaming server according to a generation time of the subtitle information and a reception time of the audio stream;
determining a display time of the subtitle information according to the time interval information; and
when determining a playback condition of the to-be-pushed live stream is met, synchronously playing the video stream and the audio stream, and displaying the subtitle information based on the display time.

15. A livestreaming data processing system, comprising:
a livestreaming server and a client, wherein
the livestreaming server is configured to: decode a received initial live stream to generate an audio stream and a first video stream; perform speech recognition on the audio stream to generate a corresponding recognition text, and determine time interval information between a generation time of the recognition text and a reception time of the audio stream; use the recognition text as subtitle information, and add the subtitle information and the time interval information to the first video stream to generate a second video stream; and encode the second video stream and the audio stream to generate a to-be-pushed live stream, and return the to-be-pushed live stream to the client; and
the client is configured to: receive and buffer the to-be-pushed live stream, decode the to-be-pushed live stream to obtain the audio stream, the second video stream, the subtitle information, and the time interval information, determine a display time of the subtitle information according to the time interval information, and when determining a playback condition of the to-be-pushed live stream is met, synchronously play the second video stream and the audio stream, and display the subtitle information based on the display time.

16. The livestreaming data processing system according to claim 15, wherein the decoding a received initial live stream comprises:
determining a to-be-played live stream buffered by the client, and determining a generation time corresponding to the to-be-played live stream; and
obtaining, according to a live stream identifier corresponding to the to-be-played live stream and the generation time corresponding to the to-be-played live stream, an initial live stream corresponding to the live stream identifier in a preset time interval, and decoding the initial live stream, wherein the preset time interval is later than the generation time corresponding to the to-be-played live stream.

17. The livestreaming data processing system according to claim 16, wherein the client decodes the to-be-played live stream to correspondingly generate a to-be-played audio stream, a to-be-played video stream, a to-be-displayed subtitle, and a display time corresponding to the to-be-displayed subtitle; and
when determining a playback condition of the to-be-played live stream is met, synchronously plays the to-be-played video stream and the to-be-played audio stream, and displays the to-be-displayed subtitle based on the display time.

18. The livestreaming data processing system according to claim 15, wherein the livestreaming server is further configured to:
determine a text type of the recognition text according to a text length and/or a text semantic meaning of the recognition text; and
correspondingly, the using the recognition text as subtitle information, and adding the subtitle information and the time interval information to the first video stream comprises:
determining a target video frame in the first video stream according to the generation time of the recognition text; and
using the recognition text as the subtitle information, and using the subtitle information, the time interval information, and the text type as video frame information of the target video frame for adding to the first video stream.

19. A computing device, comprising:
a memory and a processor, wherein
the memory is configured to store computer-executable instructions, the processor is configured to execute the computer-executable instructions, and when the processor executes the computer-executable instructions, the steps of the livestreaming data processing method according to claim 1 are implemented.

20. A non-transitory computer-readable storage medium, storing computer instructions, wherein when the instructions are executed by a processor, the steps of the livestreaming data processing method according to claim 1 are implemented.
